(19) United States
(12) Patent Application Publication
(10) Pub. No.: US 2025/0015310 A1
(43) Pub. Date: Jan. 9, 2025

(54) Rhodium Integration in Solid Oxide Fuel Cell System

(71) Applicants: UNM RAINFOREST INNOVATIONS, Albuquerque, NM (US); GOVERNMENT OF THE UNITED STATES AS REPRESENTED BY THE SECRETARY OF THE AIR FORCE, Kirtland AFB, NM (US)

(72) Inventors: Andre SPEARS, Santa Fe, NM (US); John Bryan PLUMLEY, Albuquerque, NM (US); Angelica BENAVIDEZ, Albuquerque, NM (US); Thomas L. PENG, Kirtland AFB, NM (US); Fernando GARZON, Santa Fe, NM (US)

(21) Appl. No.: 18/761,460

(22) Filed: Jul. 2, 2024

Related U.S. Application Data
(60) Provisional application No. 63/525,227, filed on Jul. 6, 2023.

(51) Int. Cl. H01M 4/92; H01M 4/86; H01M 4/88; H01M 4/90; H01M 8/12; H01M 8/1231

(52) U.S. Cl. CPC H01M 4/921; H01M 4/8846; H01M 4/9033; H01M 8/1231; H01M 2004/8684; H01M 2004/8689; H01M 2008/1293

(57) ABSTRACT

A solid oxide fuel cell (SOFC) is disclosed, including anode in contact with a fuel source, a first catalyst can include rhodium in contact with an oxidizer source, a cathode in contact with the oxidizer source, and an electrolyte disposed between the anode and the cathode. Implementations of the solid oxide fuel cell (SOFC) can include a reactor where first catalyst is in contact with the oxidizer source or a reactor with a second catalyst in contact with the fuel source. The oxidizer may include nitrous oxide, nitrogen tetraoxide, mixed oxides of nitrogen, or a combination thereof. The fuel may include ammonia, hydrazine, monomethyl hydrazine, symmetric monomethyl hydrazine, or a combination thereof. A method of providing a catalyst to an electrode for a solid oxide fuel cell is also disclosed.

### REFERENCE TO RELATED APPLICATIONS

This application claims the benefit of U.S. Provisional Patent Application No. 63/525,227, filed on Jul. 6, 2023, which is hereby incorporated by reference in its entirety.

### STATEMENT OF GOVERNMENT INTEREST

This invention was made with government support under 2RND7/2ND71/740291, RAST (Rapid Applications for Satellite Technology) awarded by the Air Force Research Laboratory New Mexico. The government has certain rights in the invention.

### TECHNICAL FIELD

The present teachings relate generally to solid oxide fuel cell systems and, more particularly, to solid oxide fuel cell systems including the use of rhodium catalysts.

### BACKGROUND

Solid oxide fuel cells (SOFCs) are efficient renewable energy devices that operate at a temperature range of 500-1000° C. The elevated temperature drives reactions, thus less expensive and more widely available ceramic materials are used instead of precious metals. SOFCs utilized in space applications are capable of using on orbit thrusters to supply fuel and oxidizer to the fuel cell as opposed to adding cryogenic tanks to the space craft thus increasing weight and cost. An oxidizer of interest is nitrous oxide (N₂O), a bipropellant from thrusters.

SOFCs can generate continuous power as long as fuel and oxidizer are supplied. These fuel cells operate with hydrogen (H₂) or ammonia (NH₃) as the fuel and O₂ or Air as the oxidizer. SOFCs consist of an electrolyte and two electrodes (anode and cathode). At the anode, the hydrogen oxidation reaction occurs in which hydrogen is in contact with the anode catalyst to produce electrons and water when combined with oxygen ions that travel through the electrolyte. Oxygen or air is supplied to the cathode where oxygen reduction reaction takes place so that oxygen ions can permeate through the electrolyte.

It is desirable to identify and develop efficient catalyst systems for SOFCs that provide usable power densities for N₂O usage as a substitute for oxygen (O₂) or air as fuel sources.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A solid oxide fuel cell (SOFC) is disclosed, including anode in contact with a fuel source, a first catalyst including rhodium in contact with an oxidizer source, a cathode in contact with the oxidizer source, and an electrolyte disposed between the anode and the cathode. Implementations of the solid oxide fuel cell (SOFC) can include a reactor where first catalyst is in contact with the oxidizer source. The first catalyst can be present on the cathode in an amount of from about 1.0 wt % to about 15 wt % based on a total weight of the cathode. The solid oxide fuel cell (SOFC) may include a reactor with a second catalyst in contact with the fuel source. The second catalyst may include iron or ruthenium. The oxidizer may include nitrogen and oxygen, for example, nitrous oxide, nitrogen tetraoxide, mixed oxides of nitrogen (MON), or a combination thereof. The fuel may include hydrogen, ammonia, hydrazine, monomethyl hydrazine, symmetric monomethyl hydrazine, or a combination thereof. The anode may include nickel oxide. The cathode may include perovskite, lanthanum strontium manganite, or lanthanum strontium cobalt iron ferrite. The oxidizer may include nitrous oxide derived from a bipropellant. The oxidizer may include nitrous oxide, nitrogen tetraoxide, mixed oxides of nitrogen, or a combination thereof. The fuel may include ammonia, hydrazine, monomethyl hydrazine, symmetric monomethyl hydrazine, or a combination thereof.

Another solid oxide fuel cell is disclosed, including a cathode which can include lanthanum strontium cobalt iron ferrite and a first catalyst in contact with an oxidizer source. The solid oxide fuel cell also includes an anode of nickel oxide and a second catalyst in contact with a fuel source. The solid oxide fuel cell also includes an electrolyte disposed between the anode and the cathode. Implementations of the solid oxide fuel cell can include where the first catalyst may include rhodium and the second catalyst may include iron or ruthenium.

A method of providing a catalyst to an electrode for a solid oxide fuel cell is disclosed, including dissolving rhodium nitrate into a water-isopropanol solvent to form a rhodium nitrate solution. The method also includes applying the rhodium nitrate solution to the electrode via incipient wetness impregnation. The method also includes heating the electrode at an elevated temperature to remove the nitrate.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic of a solid oxide fuel cell (SOFC), in accordance with the present disclosure.

FIG. 2A is a flowchart illustrating a method of providing a catalyst to an electrode for a solid oxide fuel cell, in accordance with the present disclosure. FIG. 2B a flowchart illustrating a method of operating a solid oxide fuel cell, in accordance with the present disclosure.

FIGS. 3A and 3B are VI plots of LSM cathode without Rh in (3A) H2 and (3B) NH3 fuel conditions, in accordance with the present disclosure.

FIGS. 4A and 4B are VI plots of LSCF cathode without Rh in (4A) H2 and (4B) NH3 fuel conditions, in accordance with the present disclosure.

FIGS. 5A and 5B are VI plots of LSM cathode with 1 weight % Rh in (A) H2 and (B) NH3 fuel conditions, in accordance with the present disclosure.

FIGS. 6A and 6B VI plots of LSM cathode with 5 weight % Rh in (A) H2 and (B) NH3 fuel conditions, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides improvements in the performance and operation of solid oxide fuel cells to use amine-based fuel sources, for example, ammonia, hydrazine, or hydrazine derivatives, as well as nitrogen-oxygen based oxidants, for example, nitrous oxide, nitrogen tetroxide, MON, meaning mixed oxides of nitrogen. The fuels and oxygens are nitrogen based and can require additional catalysis to become effectively oxidized in solid oxide fuel cells. This oxidation can be direct or indirect oxidation of the fuels. The heterogeneous catalysis of the decomposition of the fuels and oxidants enables improved performance in the SOFCs. Similar results can be achieved by placing catalysts upstream from the oxidizer or the fuel. The catalyst need not be incorporated directly into the cell, resulting in an indirect catalysis, as compared to incorporating a catalyst directly into the electrode structure. Additionally, in these improved solid oxide fuel cells, the decomposition of the oxidants or fuels can be endothermic or exothermic.

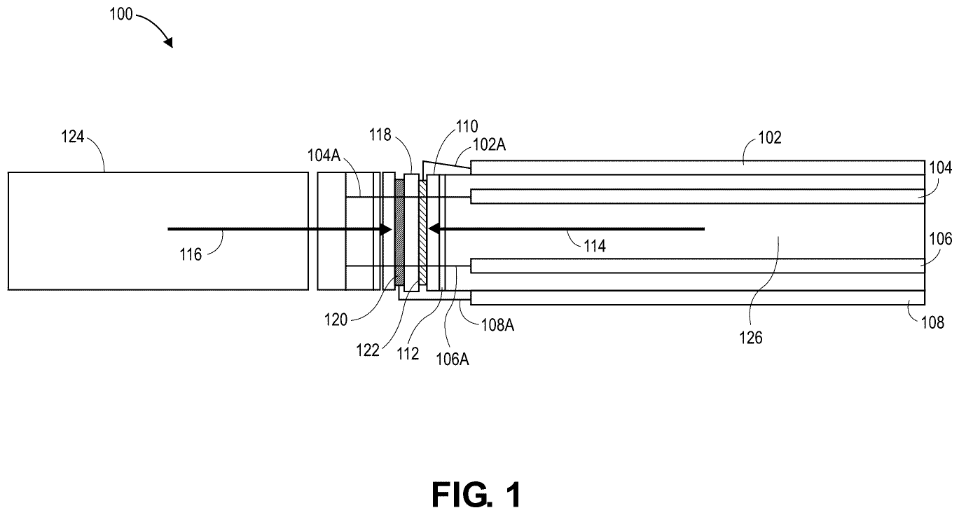

Solid oxide fuel cells (SOFCs) are efficient renewable energy devices that operate at a temperature range of 500-1000° C. The elevated temperature drives reactions, thus less expensive and more widely available ceramic materials are used instead of precious metals. SOFCs utilized in space applications are capable of using on orbit thrusters to supply fuel and oxidizer to the fuel cell as opposed to adding cryogenic tanks to the space craft thus increasing weight and cost. An oxidizer of interest is nitrous oxide (N₂O), a bipropellant from thrusters. This report identifies rhodium as a catalyst in SOFCs for N₂O usage as a substitute for oxygen (O₂) or air. A schematic of am SOFC is shown in FIG. 1.

FIG. 1 is a schematic of a solid oxide fuel cell (SOFC), in accordance with the present disclosure. A SOFC 100, includes an anode 122 in contact with a fuel source 126, a cathode 120 in contact with an oxidizer source 124, an electrolyte 118 disposed between the anode 122 and the cathode 120. As further shown in FIG. 1, a fuel intake 114 and an oxidizer intake 116 are shown on either side of the solid oxide fuel cell (SOFC) 100. In examples, the fuel source 114 and oxidizer source 116 can be integrated into the body of the SOFC 100, or be located or displaced in an external location relative to a core structure of the SOFC 100. In examples, the anode is sealed in proximity to a fuel source 126 with an alumina gasket 110 and a seal comprising Ceramabond 112. Additionally, seals can be comprised of glass ceramic sealant, such as Schott G018-394. Gaskets can also be comprised of gold (Au) or mica paper.

Also shown in the schematic of the SOFC 100 is a second lead wire insulator 108 with a second lead wire 108A in electrical contact with the cathode 120 and a first lead wire insulator 102 and first lead wire 102A in contact with the anode 122. Additionally, there is a first compression element 104 and first compression spring 104A in contact with the SOFC 100 and a second compression element 106 and second compression spring 106A in contact with the SOFC 100. The additional wires or compression elements 104 and 106 are included to help apply a compressive force to the setup of the SOFC 100 while the Ceramabond paste dries. This helps to ensure a better seal. The compression comes from additional springs (not shown in the diagram) compressing the gaskets, sealants, and fuel cell together. The wire insulator in this case is usually alumina (Al₂O₃) or zirconia (ZrO₂).

In examples, the solid oxide fuel cell (SOFC) can include a reactor including a first catalyst in contact with the oxidizer source 116. In this arrangement, the oxidizer interacts with a catalyst in the oxidizer reactor before entering the core of the fuel cell to contact the cathode. In other examples, the SOFC 100 can include a second reactor in contact with the fuel source. In this configuration, the fuel interacts with a second catalyst in the fuel reactor before entering the core of the fuel cell to contact the anode, where a second catalyst in contact with the fuel source. In still other examples, the cathode and the anode can alternatively comprise one or more catalysts within the respective electrode. In still other examples, either the cathode or anode or neither includes catalyst, and the catalysis occurs in the respective oxidizer reactor or fuel reactor, rather than at the cathode or anode. Any combination of the above-mentioned configurations can also be employed. Furthermore, for the purposes of the present disclosure, the phrase “in contact with” refers to when a fuel or oxidizer source is passed through the SOFC 100 during operation, the fuel or oxidizer can be in intimate contact with a catalyst by being transported through the SOFC 100 either in gaseous or liquid form, thus enabling a reaction to take place between the catalyst and the fuel and/or oxidizer.

In regard to the catalysts, in examples, the first catalyst is present on the cathode in an amount of from about 0.1 wt % to about 15 wt % based on a total weight of the cathode, or from about 1.0 wt % to about 10 wt % of catalyst, or from about 1.0 wt % to about 5 wt % of catalyst for either the cathode or the external reactor. The first catalyst on the cathode/oxidizer side of the solid oxide fuel cell (SOFC) 100 can include rhodium in contact with the oxidizer. In examples, a lanthanum catalyst, such as LSCF or LSM, or a lanthanum catalyst in combination with a rhodium catalyst can alternatively be used in contact with the oxidizer source. The second catalyst on the anode/fuel side of the solid oxide fuel cell (SOFC) 100 can include iron or ruthenium.

Illustrative examples of oxidizers applicable to the present teachings include oxidizers comprising nitrogen and oxygen, such as, but not limited to, nitrous oxide, nitrogen tetraoxide, mixed oxides of nitrogen (MON), or a combination thereof. In examples, the oxidizer can include nitrous oxide (N₂O) or other oxidizers derived from a bipropellant. Illustrative examples of fuels applicable to the present teachings include fuels such as, but not limited to, hydrogen, or amine-containing fuels including ammonia (NH₃), hydrazine, monomethyl hydrazine, symmetric monomethyl hydrazine, or a combination thereof. Additional examples of oxidizers can include air, O₂, dinitrogen tetroxide (N₂O₄), nitrogen dioxide (NO₂), and hydrogen peroxide (H₂O₂).

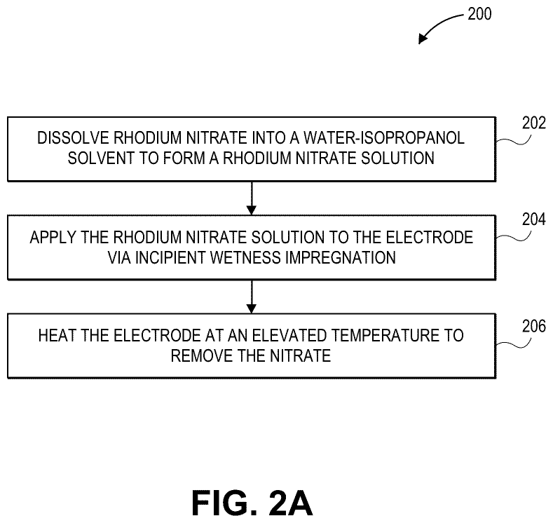

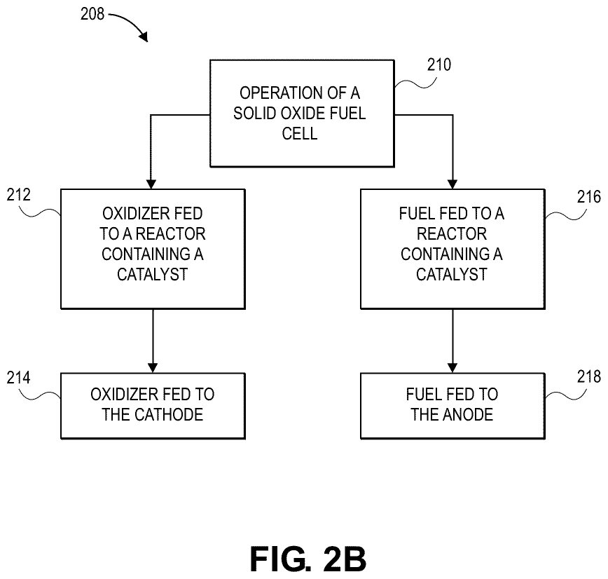

FIG. 2A is a flowchart illustrating a method of providing a catalyst to an electrode for a solid oxide fuel cell, in accordance with the present disclosure. The method of providing a catalyst to an electrode for a solid oxide fuel cell 200, includes dissolving rhodium nitrate into a water-isopropanol solvent to form a rhodium nitrate solution 202, applying the rhodium nitrate solution to the electrode via incipient wetness impregnation 204, and heating the electrode at an elevated temperature to remove the nitrate 206. In examples, heating the electrode comprises sintering at a temperature of 450° C. for two hours. For the Rh modification of the cathode, additive manufacturing techniques such as aerosol jet spray, 3D printing, and screen printing can alternatively be employed. Other materials could include any Rh compound that can be dissolved into a solvent which can be drop casted or applied with any kind of printing nozzle onto or into (infiltrating) the porous cathode.

FIG. 2B is a flowchart illustrating the operation of a solid oxide fuel cell, in accordance with the present disclosure. The process 208 for operating the solid oxide fuel cell 210 of the present disclosure includes two major reaction pathways. A first pathway includes a step of feeding oxidizer to a reactor including a catalyst 212 and feeding the oxidizer to the cathode 214. These steps of feeding oxidizer to a reactor including a catalyst 212 and feeding the oxidizer to the cathode 214 can each be optional, or can be accomplished together, either in succession or simultaneously. For example, the catalyst in the cathode/oxidizer side of the reaction can be located in an external reactor vessel or container or impregnated in the cathode. Exemplary catalysts for this process can include rhodium, or for use in the external reactor, LSCF and LSM powder catalyst can be incorporated along with Rh. A second pathway includes the steps of feeding fuel to a reactor containing a catalyst 216 and feeding fuel to the anode 218. These steps of feeding fuel to a reactor containing a catalyst 216 and feeding fuel to the anode 218 can also each be optional, or can be accomplished together, either in succession or simultaneously. In examples, catalyst in the anode/fuel side of the reaction can be located in an external reactor vessel or container or impregnated in the anode. Exemplary catalysts for this process can include iron or ruthenium. For the external reactor vessel on the fuel side steel wool catalyst can also be used. In examples, the decomposition of ammonia (NH₃), which is endothermic, could be carried out and heated in an exhaust stream on or connected to the fuel cell. A reaction of monomethyl hydrazine is exothermic, and can occur in an area connected to the fuel cell as well. As noted previously, the catalyst does not necessarily need to be on or entrained within the anode or cathode, it can be dislocated from the anode or cathode. Common oxidants, containing nitrogen and oxygen, used in the processes of the present disclosure can include nitrogen oxides, nitrous oxide, nitrogen tetraoxide, MON, or combinations thereof. Common fuels used in the processes of the present disclosure can include amine-based fuel sources, for example, ammonia, hydrazine, or hydrazine derivatives, or combinations thereof. The catalysts aid in decomposition of the fuels and oxidants used in these propulsion systems, including air independent propulsion systems. Other oxidizers can include, but are not limited to, air, O₂, dinitrogen tetroxide (N₂O₄). Hydrogen peroxide (H₂O₂), nitrogen dioxide (NO₂), and dinitrogen dioxide (N₂O₄).

SOFCs can generate continuous power as long as fuel and oxidizer are supplied. The fuel cells of the present disclosure can operate with hydrogen (H₂) or ammonia (NH₃) as the example fuels and O₂ or air as an exemplary oxidizer. Other oxidizers and fuels as noted herein may be used alternatively. SOFCs include an electrolyte and two electrodes, including an anode and a cathode. At the anode, the hydrogen oxidation reaction occurs in which hydrogen is in contact with the anode catalyst to produce electrons and water when combined with oxygen ions that travel through the electrolyte. Oxygen or air is supplied to the cathode where oxygen reduction reaction takes place so that oxygen ions can permeate through the electrolyte. Below are the chemical equations that produce electrical energy.

Fuel: H₂+O₂—→H₂O+2ₑ-

Fuel: 2NH₃+3O₂—→N₂+3H₂O+6e-

Oxidizer: 12O₂+2e-→O₂—

An alternative to the conventional air or O₂ is nitrous oxide (N₂O). This nitrogen-based bipropellant is used as an oxygen carrier to supply the cathode with oxidizer. N₂O is an excellent candidate for use in SOFCs due to its higher O₂ concentration than air and because of its exothermicity when it converts to O₂ and nitrogen (N₂).

Oxidizer: N₂O+2e-→N₂+O₂—

In the present teachings, commercial button cells are investigated as surrogates for larger SOFCs. These button cells are miniature versions of SOFCs that are employed for testing and power generation. Button cells have a 20 mm diameter with a 60-65 μm thickness. Testing is conducted with commercial cells to understand performance by varying conditions and materials prior to scaling up for real-life applications. Commercial cells include a nickel-oxide (NiO) anode and a perovskite cathode. Two types of cathodes have been studied: lanthanum strontium manganite, (LaSr) MnO₃, (LSM) and lanthanum strontium cobalt iron ferrite, (LaSr)(CoFe)O₃, (LSCF). Other applicable cathodes can include those fabricated with additional cathode materials including chromite (LSCM). Anode compositions can include nickel oxide, or other oxides, such as TiO₂, CeO₂, Y₂O₃, La₂O₃, MgO, or combinations thereof.

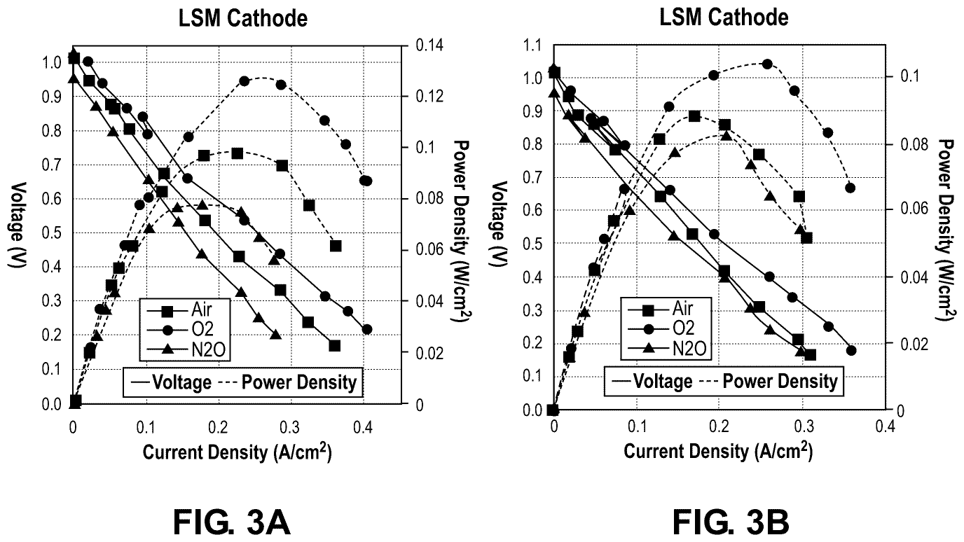

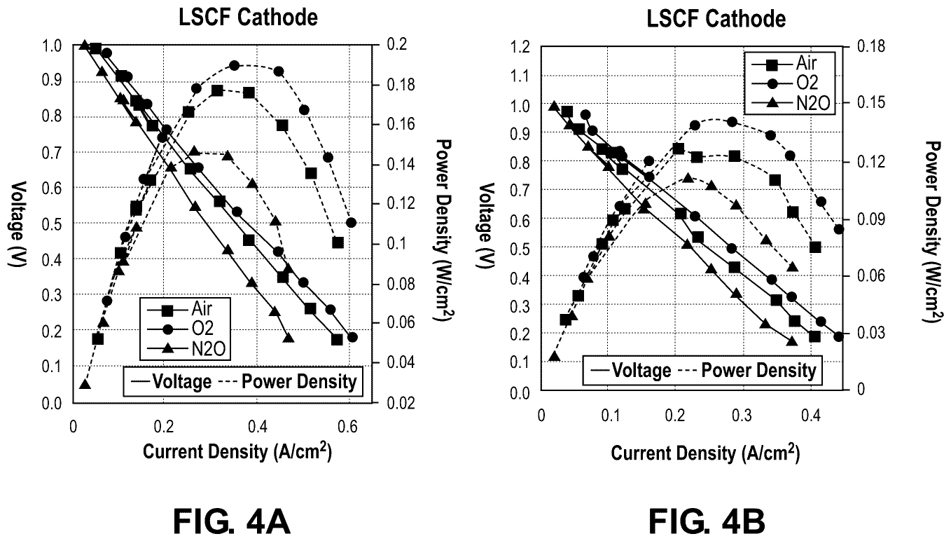

Fuel cell performance can be measured with polarization (VI) curves to show voltage and power generated as a function of current density. Testing was conducted at 800° C. at ambient pressure with 150 sccm flow for H₂ fuel and 75 sccm flow for oxidizers. These tests were evaluated with H₂ fuel and multiple oxidizers, Air, O₂ and N₂O. The concentration of O₂ is 100%, Air has 21%, and N₂O is 36%. The expectation is that the performance trend will be O₂>N₂O>Air. Two types of cathodes were analyzed, LSM and LSCF. Results show that oxygen generates the most power, as shown in FIGS. 3A, 3B, 4A, and 4B. Air had a higher power output than N₂O, yet N₂O has a higher O₂ concentration than Air. These results are consistent for both LSM and LSCF cathodes with numerous button cells.

Rhodium (Rh) is a precious metal catalyst that can be used within the present disclosure for converting nitrogen oxides into nitrogen and oxygen. It is understood that Rh decomposes N₂O more effectively than many transition metals. While Rh has been used in SOFCs with NiO anodes to help reform methane, the use of Rh with LSM or LSCF cathode for application in SOFCs is not well-established.

2NOxRh→xO₂+N₂

Rh can be added to commercial LSM and LSCF cathodes. Rh-nitrate catalyst is added to a water-isopropanol solvent. This solution is then placed on the cathode via incipient wetness impregnation. Once the desired weight % is achieved the sample is sintered at 450° C. for 2 hours to remove the nitrate. After sintering, the sample was prepared for fuel cell testing. While not limited to this method, for example, the use of mechanical mixing, chemical vapor deposition (CVD), physical vapor deposition (PVD) and other methods, as long as the catalyst is distributed within the porous electrode, or otherwise available to either the oxidizer or fuel source. In other examples, the rhodium could be incorporated into a precursor mixture for forming an electrode, such as a cathode, where the rhodium with precursor will phase separate and form rhodium nanoparticles in one or more surfaces of the cathode material.

Fuel cell measurements were repeated but with Rh catalyst, testing was conducted with the same conditions mentioned previously. Four samples have been studied so far, as shown in FIGS. 3A-6B. These experiments included LSM 1 that has 1 weight %, LSM 5 and LSCF 5 both have 5 weight %, and LSCF 10 in which 10 weight % was incorporated. Oxygen continued to generate the most power. Rh integration showed that N₂O produced similar or equal power as air signifying the higher conversion of N₂O to N₂ and O₂. The performance between air and N₂O is consistent regardless of cathode (LSM or LSCF) or weight % (5% or 10 weight % with LSCF). Rh increased power output of O₂ and N₂O in the case of LSCF 5 weight % by a 30% minimum illustrating Rh's impact. Tables 1 and 2 provide the maximum power density of each cell studied in H₂ and NH₃, respectively.

FIGS. 3A and 3B are I-V plots of LSM cathode without Rh in (3A) H₂ and (3B) NH₃ fuel conditions, in accordance with the present disclosure. The plots shown are I-V characterization curves that can be considered an evaluation of the performance of the fuel cell. Power density is calculated from the respective voltage and current density. The I-V data is generated using a potentiostat while fuel and oxidizer are flowing to the heated fuel cell. Resulting currents are recorded as a voltage is applied across the cell and varied. FIG. 3A contains current density and power density performance of the NiO anode/LSM cathode (non-Rh modified) commercial SOFC running on H₂ fuel comparing cell performance between three oxidizers (air, N₂O, and O₂). FIG. 3B is the same NiO anode/LSM cathode (non-Rh modified) commercial SOFC running on NH₃ fuel comparing performance between the same three oxidizers.

FIGS. 4A and 4B are I-V plots of LSCF cathode without Rh in (4A) H₂ and (4B) NH₃ fuel conditions, in accordance with the present disclosure. FIG. 4A is the NiO anode/LSCF (non-Rh modified) cathode running on H₂ comparing cell performance between air, N₂O, and O₂. The plot shown in FIG. 4B is the same NiO anode/LSCF (non-Rh modified) cathode running on NH₃ comparing cell performance between the same three oxidizers as FIG. 4A.

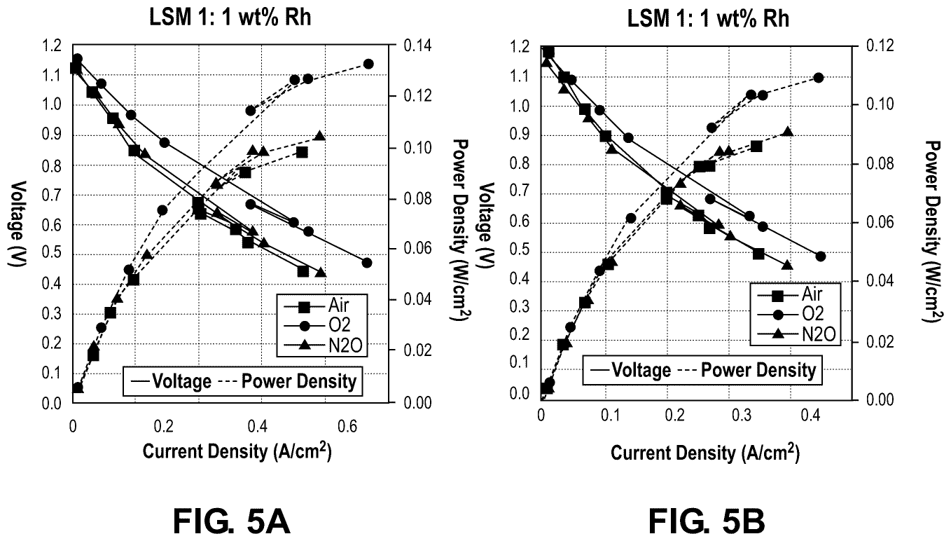

FIGS. 5A and 5B are I-V plots of LSM cathode with 1 weight % Rh in (A) H₂ and (B) NH₃ fuel conditions, in accordance with the present disclosure. FIG. 5A contains current and power density data of the fuel cell with the Rh modified (1 weight %) LSM cathode running on H₂ fuel comparing performance between the three oxidizers. The plot shown in FIG. 5B is the performance evaluation of the Rh-modified LSM cathode running on NH₃ fuel comparing the three separate oxidizers (air, N₂O, and O₂).

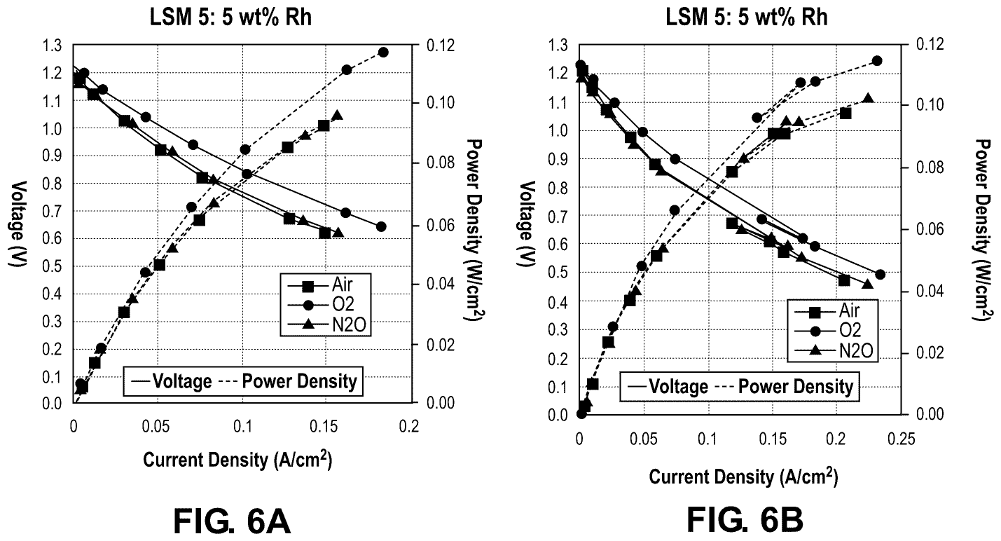

FIGS. 6A and 6B I-V plots of LSM cathode with 5 weight % Rh in (A) H₂ and (B) NH₃ fuel conditions, in accordance with the present disclosure. FIGS. 6A and 6B include the performance data of the 5 weight % Rh modified LSM cathode running on H₂ and NH₃ fuel, respectively. Maximum power densities were identified from the figures and used as comparative values to evaluate the effect of Rh modification of the cathode on the performance of the fuel cells, which was then recorded in Tables 1 and 2, below. The main finding was that adding an appropriate amount of Rh to the cathode resulted in better performance of the cells running on N₂O oxidizer compared to the non-Rh modified cell. For instance, Table 1 shows that when the LSCF cathode is modified with 5 weight % Rh, the cell running on H₂ fuel and N₂O oxidizer improves by 20% (0.15 W/cm² for the non-Rh modified LSCF to 0.18 W/cm² for the Rh modified LSCF). In addition, the Rh-modified cell runs with a maximum power density from the N₂O oxidizer comparable to that of the same Rh-modified cell running on air. However, when too high of a Rh weight % is used, then the performance of the cell starts to be negatively affected (compare power densities in the LSCF 10 row with the LSCF 5 row in Table 1). This is believed to be due to too much Rh possibly blocking the pores, negatively affecting the conductivity of the cathode.

TABLE 1
Maximum power densities of button cells tested in H2 fuel
and X oxidizers conditions with varying Rh weight %.
Maximum Power Density (W/cm2) in H2

| Sample | Rh weight % | Air | O₂ | N₂O |
|---|---|---|---|---|
| LSCF | 0 | 0.18 | 0.19 | 0.15 |
| LSCF 5 | 5 | 0.18 | 0.25 | 0.18 |
| LSCF 10 | 10 | 0.14 | 0.18 | 0.13 |
| LSM | 0 | 0.2 | 0.21 | 0.18 |
| LSM 1 | 1 | 0.13 | 0.09 | 0.105 |
| LSM 5 | 5 | 0.095 | 0.12 | 0.095 |

TABLE 2
Maximum power densities of button cells tested in NH3 fuel
and X oxidizers conditions with varying Rh weight %.
Maximum Power Density (W/cm2) in NH3

| Sample | Rh weight % | Air | O₂ | N₂O |
|---|---|---|---|---|
| LSCF | 0 | 0.12 | 0.14 | 0.11 |
| LSCF 5 | 5 | 0.13 | 0.17 | 0.13 |
| LSCF 10 | 10 | 0.082 | 0.094 | 0.078 |
| LSM | 0 | 0.088 | 0.10 | 0.083 |
| LSM 1 | 1 | 0.086 | 0.11 | 0.09 |
| LSM 5 | 5 | 0.098 | 0.115 | 0.10 |

It can be observed that Rh catalyst improves N₂O utilization in SOFCs as a replacement for O₂ or Air. The results suggest that Rh is effective in breaking down N₂O into N₂ and O₂. The activity of Rh is consistent with different cathodes, LSM and LSCF, as well as with varying weight %. Using Rh allows space technology to reduce cost by not incorporating a catalyst bed to break down the bipropellant, instead decomposition occurs at the cathode surface with the catalyst. More importantly, air or O₂ will not have to be stowed, removing the need for tanks to supply the SOFC with oxidizer. The incorporation of Rh allows N₂O to be effective in SOFCs application.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A solid oxide fuel cell (SOFC), comprising:
an anode in contact with a fuel source;
a first catalyst comprising rhodium, lanthanum, or a combination thereof in contact with an oxidizer source;
a cathode in contact with the oxidizer source; and
an electrolyte disposed between the anode and the cathode.

2. The solid oxide fuel cell (SOFC) of claim 1, further comprising a reactor comprising the first catalyst in contact with the oxidizer source.

3. The solid oxide fuel cell (SOFC) of claim 1, wherein the first catalyst is present on the cathode in an amount of from about 0.1 wt % to about 15 wt % based on a total weight of the cathode.

4. The solid oxide fuel cell (SOFC) of claim 1, further comprising a reactor comprising a second catalyst in contact with the fuel source.

5. The solid oxide fuel cell (SOFC) of claim 4, wherein the second catalyst comprises iron.

6. The solid oxide fuel cell (SOFC) of claim 4, wherein the second catalyst comprises ruthenium.

7. The solid oxide fuel cell (SOFC) of claim 1, wherein the oxidizer comprises nitrogen and oxygen.

8. The solid oxide fuel cell (SOFC) of claim 1, wherein the oxidizer comprises nitrous oxide, nitrogen tetraoxide, mixed oxides of nitrogen (MON), or a combination thereof.

9. The solid oxide fuel cell (SOFC) of claim 1, wherein the fuel comprises hydrogen (H₂).

10. The solid oxide fuel cell (SOFC) of claim 1, wherein the fuel comprises ammonia (NH₃), hydrazine, monomethyl hydrazine, symmetric monomethyl hydrazine, or a combination thereof.

11. The solid oxide fuel cell (SOFC) of claim 1, wherein the anode comprises nickel oxide.

12. The solid oxide fuel cell (SOFC) of claim 1, wherein the cathode comprises perovskite.

13. The solid oxide fuel cell (SOFC) of claim 1, wherein the cathode comprises lanthanum strontium manganite (LSM).

14. The solid oxide fuel cell (SOFC) of claim 1, wherein the cathode comprises lanthanum strontium cobalt iron ferrite (LSCF).

15. The solid oxide fuel cell (SOFC) of claim 1, wherein the oxidizer comprises nitrous oxide (N₂O) derived from a bipropellant.

16. A solid oxide fuel cell (SOFC), comprising:
a cathode comprising lanthanum strontium cobalt iron ferrite (LSCF) and a first catalyst in contact with an oxidizer source;
an anode comprising nickel oxide and a second catalyst in contact with a fuel source; and
an electrolyte disposed between the anode and the cathode.

17. The solid oxide fuel cell (SOFC) of claim 16, wherein the first catalyst comprises rhodium and the second catalyst comprises iron or ruthenium.

18. The solid oxide fuel cell (SOFC) of claim 15, wherein the oxidizer comprises nitrous oxide, nitrogen tetraoxide, mixed oxides of nitrogen (MON), or a combination thereof.

19. The solid oxide fuel cell (SOFC) of claim 15, wherein the fuel comprises ammonia (NH₃), hydrazine, monomethyl hydrazine, symmetric monomethyl hydrazine, or a combination thereof.

20. A method of providing a catalyst to an electrode for a solid oxide fuel cell, comprising:
dissolving rhodium nitrate into a water-isopropanol solvent to form a rhodium nitrate solution;
applying the rhodium nitrate solution to the electrode via incipient wetness impregnation; and
heating the electrode at an elevated temperature to remove the nitrate.
